(19) United States
(12) Patent Application Publication
(10) Pub. No.: US 2025/0094814 A1
(43) Pub. Date: Mar. 20, 2025

(54) FINE-TUNING A LARGE LANGUAGE MODEL (LLM) TO REDUCE THE INSTABILITY OF LLM OUTPUTS TO VARIATIONS IN PROMPTS

(71) Applicant: Oracle International Corporation, Redwood Shores, CA (US)

(72) Inventors: Zheng Wang, Sammamish, WA (US); Yazhe Hu, Bellevue, WA (US); Mengqing Guo, Redmond, WA (US); Tao Sheng, Bellevue, WA (US); Jun Qian, Bellevue, WA (US); Vinod M Mamtani, Bellevue, WA (US)

(21) Appl. No.: 18/824,570

(22) Filed: Sep. 4, 2024

Related U.S. Application Data
(60) Provisional application No. 63/538,755, filed on Sep. 15, 2023.

(51) Int. Cl. G06N 3/0895

(52) U.S. Cl. CPC G06N 3/0895

(57) ABSTRACT

Techniques are provided for fine-tuning large language models (LLMs) to reduce the instability of LLM outputs to prompt. In one technique, a plurality of prompts is stored. For each prompt of the plurality of prompts, a plurality of variants of that prompt is generated. A prompt generating LLM is fine-tuned based on that prompt and the plurality of variants. Each variant-prompt association (where the variant is generated based on the prompt and has an identical or similar meaning) is a training sample that is used to train or fine-tune the prompt generating LLM. The prompt generating LLM is configured to generate standardized prompts based on input prompts. In another technique, a response generating LLM is fine-tuned based on sets of training samples, each training sample in a set comprising a different variant of a prompt and a response that the response generating LLM generated based on the prompt.

### BENEFIT CLAIM

This application claims the benefit of Provisional Application 63/538,755, filed Sep. 15, 2023, the entire contents of which is hereby incorporated by reference as if fully set forth herein, under 35 U.S.C. § 119 (e).

### TECHNICAL FIELD

The present disclosure relates to large language models (LLMs) and, more particularly, to prompt engineering to improve LLM outputs that are based on prompts.

### BACKGROUND

LMs (particularly large LMs or LLMs) trained on web scale text have recently demonstrated unprecedented abilities across a variety of natural language processing (NLP) tasks. These LLMs use prompt inputs to follow human instructions. While LLMs have shown great promise in generating natural language outputs, prompting these models can be a delicate process. Writing natural language prompts remains a manual trial-and-error process requiring significant human effort and expertise. Even slight modifications to a prompt can cause significant variations in LLM predictions or outputs, making prompting a brittle process. To overcome this challenge, researchers have proposed various methods for prompt engineering. For example, one tool allows implementing, improving, and testing individual nodes of LLM prompts. Additionally, reframing prompts has been suggested to make prompts more amenable to LLM language and generate coherent answers. However, there is still a lack of effective general-purpose prompt engineering techniques to mitigate instability issues in LLMs. Accordingly, there is a need for automatic or semiautomatic procedures to help users write the best prompts. This would help reduce manual effort, improve task performance, and produce interpretable descriptions of a cognitive decision process.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system that leverages a prompt LLM to generate standardized prompts;

FIG. 2 is a block diagram that depicts an example system for fine-tuning a prompt generating LLM, in an embodiment;

FIG. 3 is a flow diagram that depicts an example process for fine-tuning a prompt generating LLM, in an embodiment;

FIG. 4 is a block diagram that depicts an example system for fine-tuning a response generating LLM that accepts prompts generated by a prompt generating LLM, in an embodiment;

FIG. 5 is a flow diagram that depicts an example process for fine-tuning a response generating LLM, in an embodiment;

FIG. 6 is a block diagram that illustrates a computer system upon which an embodiment of the invention may be implemented;

FIG. 7 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for fine-tuning a prompt generating LLM to reduce the instability of LLM outputs are provided. In one technique, multiple prompts are stored. For each prompt, multiple variants are automatically generated. A training dataset for a prompt generating LLM is generated based on each prompt and its associated generated variants. The prompt generating LLM is trained/fine-tuned based on the training dataset. In a related technique, a second training dataset is generated based on an output prompt from the prompt generating LLM and output from a second LLM. The output from the second LLM is based on a prompt that is associated with the output prompt. The second LLM is trained/fine-tuned based on the second training dataset.

Embodiments improve computer-related technology, particularly prompt engineering. Embodiments reduce manual effort in coming up with accurate prompts and reduce the instability and variability in LLM output.

### System Overview

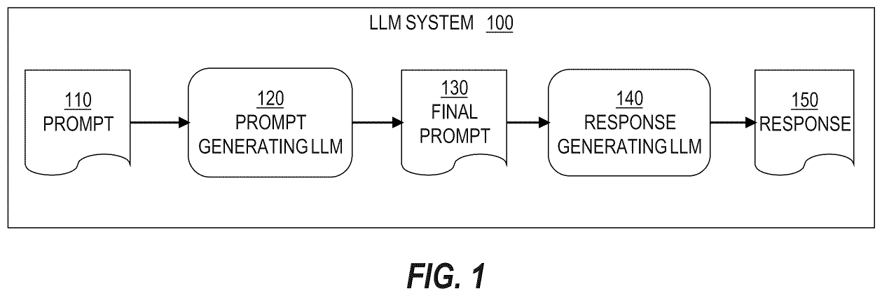

FIG. 1 is a block diagram that depicts an example system 100 that leverages a prompt generating LLM to generate standardized prompts, in an embodiment. System 100 includes a query prompt 110 that is manually specified by a human user, whether the user typed the prompt using a keyboard or whether the user spoke the prompt and an audio-to-text processor converts the audio data to text data. System 100 also includes a prompt generating LLM 120 that accepts query prompt 110 and generates a final prompt 130, which may be different than query prompt 110. For example, a query prompt may be “What is the best known song of the artist who originally recorded the song ‘A thousand times a day’?” A final prompt that is based on that query prompt may be “Who is the artist of the song ‘A thousand times a day’? What is the most popular song of that artist? Return the name of that most popular song.” In this example, the query prompt is divided into shorter questions, which increases the chances that the response generating LLM generates a correct or accurate response.

Final prompt 130 may be considered a standardized version of query prompt 110. For example, prompt generating LLM 120 may identify multiple instructions in a single sentence of query prompt 110 and split those multiple instructions into individual sentences. As another example, prompt generating LLM 120 may modify some words or phrases that are uncommon and convert them to more common words or phrases. This will increase the likelihood that response generating LLM 140 generates a response that is intended by the user that submitted query prompt 110. Final prompt 130 is input to response generating LLM 140, which outputs a response 150 that is based on instructions that response generating LLM 140 identifies in final prompt 130.

Without training or fine-tuning of prompt generating LLM 120 and/or of response generating LLM 140, one problem with system 100 is that prompt generating LLM 120 often does not generate a standardized prompt. Another problem is that system 100 often generates varying prompts despite the same input prompt.

### Fine-Tuning a Prompt Generating LLM

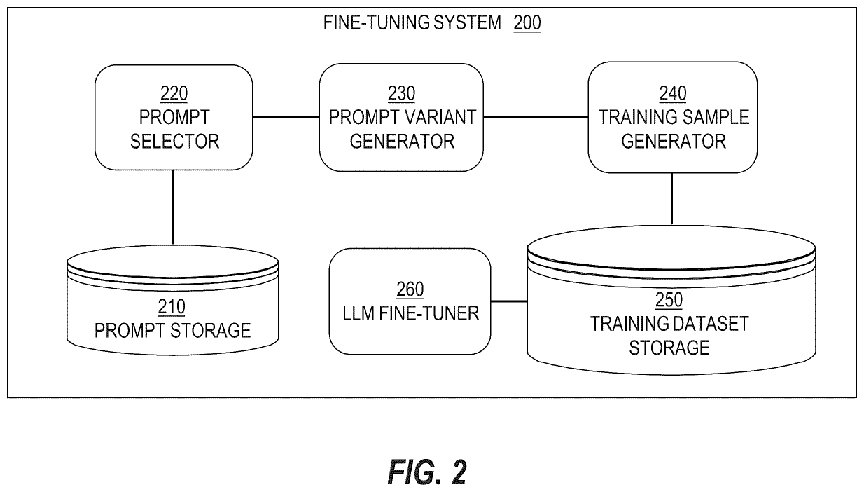

FIG. 2 is a block diagram that depicts an example system 200 for fine-tuning a prompt generating LLM, such as prompt generating LLM 120, in an embodiment. System 200 includes a prompt storage 210, a prompt selector 220, a prompt variant generator 230, a training sample generator 240, a training dataset storage 250, and an LLM fine-tuner 260. Prompt selector 220, prompt variant generator 230, training sample generator 240, and LLM fine-tuner 260 may be implemented in hardware, software, or any combination of hardware and software.

Prompt storage 210 stores multiple prompts. Such prompts may have been specified manually (e.g., approved manually by administrators of process 200) or may have been selected from a prompt log of past prompts that a prompt generating LLM has seen. In an embodiment, a component of system 200 (e.g., prompt selector 220) (or of another system) automatically selects prompts from a prompt log based on the corresponding output from an LLM being deemed “good” or rated positively. For example, if output from a response generating LLM is labeled or rated (whether manually or automatically) as “good” or has a relevance score above a certain score threshold, then the prompt that initiated that output is identified as “good” or is assigned a high rating or score.

Prompt selector 220 selects a prompt from prompt storage 210 for inputting to prompt variant generator 230. This selection may be in response to user input and/or based on one or more criteria being satisfied. For example, prompt selector 220 may be triggered to fine-tune a prompt generating LLM in response to a request from a computing device operated by a user, such as an administrator of system 200. As another example, prompt selector 220 may be triggered to fine-tune a prompt generating LLM regularly, such as daily or weekly, in which case no explicit user-initiated request is necessary. As another example, prompt selector 220 may be triggered in response to determining that the prompt generating LLM is performing poorly as indicated by one or more performance metrics.

When prompt selector 220 is triggered, it may select a predetermined (or preconfigured) number of prompts from prompt storage 210. Alternatively, a user-initiated request may specify a number of prompts to select from prompt storage 210.

Prompt variant generator 230 automatically generates variants of each prompt that prompt selector 220 selects. Prompt variant generator 230 may implement one or more variant generating techniques, such as switching nouns and verbs with synonyms of those nouns and verbs, replacing first person language with third person language, changing grammar, etc. For example, words like “big” may be associated with synonyms “large” and “huge.” For example, prompt variant generator 230 has access to a digital thesaurus that maps each word or phrase (e.g., found in a dictionary) to one or more synonyms. The variants of a prompt may be different in word choices and/or sentence structures. Some of the variant generating techniques may be rule-based while others may be AI-based or deep learning based.

A variant generating technique may be implemented in one or more variant generating operations that prompt variant generator 230 invokes. Depending on the variant generating operation, a single invocation of a variant generating operation may result in a single variant, multiple variants, or zero variants. For example, a variant generating operation that produces synonyms of a given word or phrase may result in multiple variants if a word or phrase has multiple synonyms. As another example, a variant generating operation that changes first person language to third person language may only produce a single variant, if any. For example, if a prompt is already in third person language, then the variant generating operation might detect that and not generate any output.

After prompt variant generator 230 generates one or more variants for a selected prompt, training sample generator 240 generates a training sample based on the prompt and its variants and stores the training sample in training dataset storage 250. For example, if prompt variant generator 230 generates four variants of a prompt, then training sample generator 240 generates five training samples, one for each of the four variants and one for the prompt from which the variants were generated. The target of each training sample is the same, which is an output prompt that the prompt generating LLM generates based on the “original” prompt (i.e., from which the variants were generated) as input. For generative NL (natural language) model training, a possible data format is in the format of a text paragraph. The paragraph has two parts: the prompt and completion. The prompt is the query that includes instructions, examples, and/or questions. The completion is the text that we desire the LLM to generate in response to receiving the prompt. The “prompt+completion” may be in a text paragraph format.

A collection of training samples in training dataset storage 250 becomes a training dataset from which LLM fine-tuner 260 reads in order to fine-tune the prompt generating LLM. A goal of fine-tuning the prompt generation LLM is to “force” or train the prompt generating LLM to generate the same original prompt given one or more variants of that original prompt.

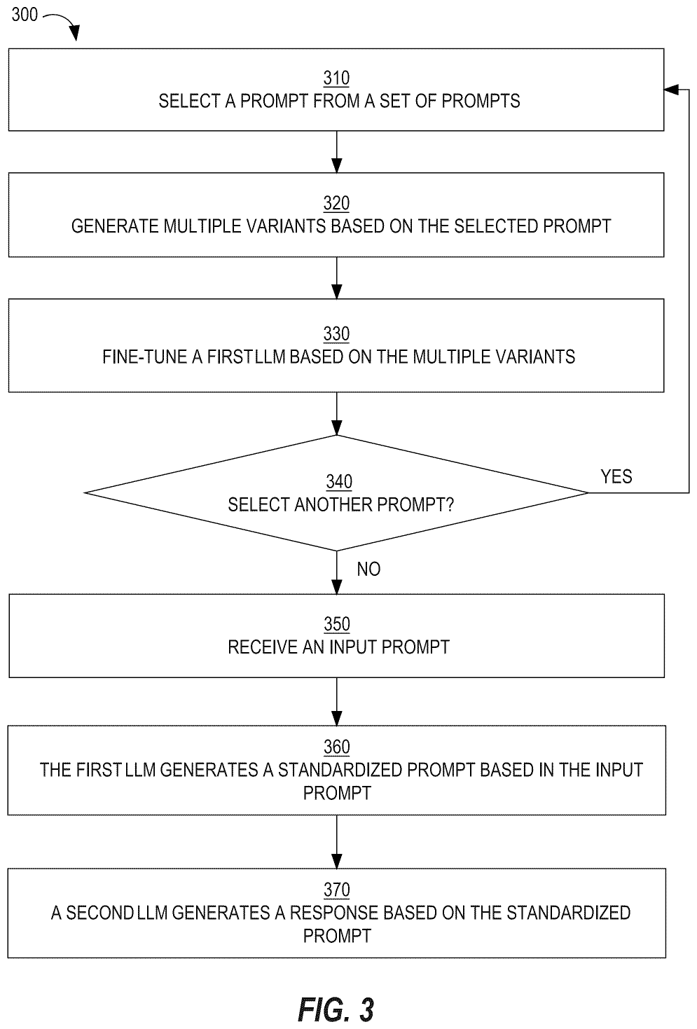

FIG. 3 is a flow diagram that depicts an example process 300 for fine-tuning a prompt generating LLM, in an embodiment. Process 300 may be implemented by different components of system 200.

At block 310, a prompt is selected from a set of prompts. The selection may be performed randomly or serially. Alternatively, not all prompts in the set of prompts are eventually selected. For example, a prompt (or its corresponding output from an LLM) is required to satisfy one or more criteria in order to be selected.

At block 320, multiple variants are generated based on the selected prompt. Block 320 may involve performing only a single variant generating operation or performing multiple variant generating operations.

At block 330, a first LLM is fine-tuned based on the multiple variants. Block 330 may be preceded by the first LLM generating an output prompt based on the selected prompt and then, for each variant of the multiple variants, generating a training sample that comprises that variant and the output prompt, and adding the training sample to a training dataset. Thus, block 330 may involve fine-tuning the first LLM based on the training samples in the training dataset.

At block 340, it is determined whether to select another prompt in the set of prompts that has not yet been selected. If so, then process 300 returns to block 310; otherwise, process 300 proceeds to block 350.

At block 350, an input prompt is received. The input prompt may be different than any prompt in the set of prompts. For example, the input prompt may be received from a computing device that is remote relative to systems 100, 200 and that is operated by a user who is requesting, through the input prompt, information from system 100.

At block 360, the first LLM generates a standardized prompt based on the input prompt. Block 360 comprises inputting the input prompt to the first LLM.

At block 370, a second LLM generates a response based on the standardized prompt as input to the second LLM. The second LLM is a response generating LLM.

### Fine-Tuning a Response Generating LLM

Even after fine-tuning a prompt generating LLM, there is no guarantee that the prompt generating LLM will generate the same prompt given a set of variants, especially for a new prompt and variants that the prompt generating LLM has never seen before. Therefore, a response generating LLM may generate different responses in response to different prompts that are requesting the same information. Therefore, in an embodiment, a response generating LLM is fine-tuned to generate the same response even with different prompts as input.

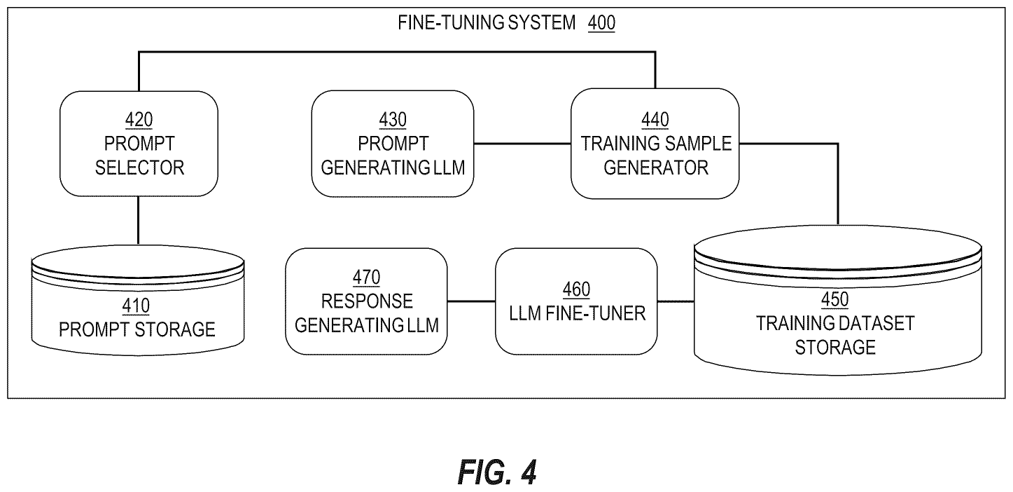

FIG. 4 is a block diagram that depicts an example system 400 for fine-tuning a response generating LLM that accepts prompts generated by a prompt generating LLM, in an embodiment. System 400 includes a prompt storage 410, a prompt selector 420, a prompt generating LLM 430, a training sample generator 440, a training dataset storage 450, an LLM fine-tuner 460 and a response generating LLM 470. Prompt selector 420, prompt generating LLM 430, training sample generator 440, LLM fine-tuner 460, and response generating LLM 470 may be implemented in hardware, software, or any combination of hardware and software.

Similar to prompt storage 210, prompt storage 410 stores multiple prompts. Such prompts may be specified manually (e.g., approved manually by administrators of system 400) or may have been selected from a prompt log of past prompts that a prompt generating LLM has received. Such automatically-selected prompts may be selected based on the corresponding output from an LLM being deemed good or rated positively.

Prompt storage 410 may be the same as, or different than, prompt storage 210. If different, then prompt storage 410 may contain different prompts and, therefore, different variants. Alternatively, prompt storage 410 may contain the same prompts as prompt storage 210, but different variants for those prompts.

Prompt selector 420 selects prompts from prompt storage 410 for inputting to prompt generating LLM 430. Prompt selector 420 may select each prompt in prompt storage 410, in which case the prompts in prompt storage 410 may have already been curated. Alternatively, prompt selector 420 applies one or more selection criteria to selecting prompts and/or variants from prompt storage 410. For example, if prompt selector 420 selects a prompt that has one or more variants that were used to fine-tune prompt generating LLM 430, then prompt selector 420 selects one or more other variants of the prompt, which other variant(s) were not used to fine-tune prompt generating LLM 430.

Training sample generator 440 invokes prompt generating LLM 430 for each selected prompt and/or corresponding selected variants. In turn, prompt generating LLM 430 generates a standardized prompt for each invocation. Thus, if a prompt has five variants (e.g., five variants that were not used to fine-tune prompt generating LLM 430), then prompt generating LLM 430 may generate six standardized prompts, one for the selected prompt and one for each of the five variants thereof.

In order to generate training samples based on a selected prompt, training sample generator 440 invokes response generating LLM 470 using the standardized prompt of the selected prompt as input. In response, response generating LLM 470 generates output based on the standardized prompt of the selected prompt. This output is referred to as the “original output.”

Training sample generator 440 generates multiple training samples where the original output is used as a label or target text for fine-tuning response generating LLM 470. For each of the multiple training samples, training sample generator 440 includes a different one of the standardized prompts from the variants. In the example where five variants of a selected prompt are selected, training sample generator 440 generates five training samples, where each training sample has a different standardized prompt from the five variants, but where the original output is the label or target text in each training sample. Training sample generator 440 stores the training samples in training dataset storage 450. Training dataset storage 450 stores training samples, where some are generated based on one selected prompt and others are generated based on another selected prompt.

LLM fine-tuner 460 fine-tunes response generating LLM 470 based on the training samples in training dataset storage 450. Such fine-tuning trains response generating LLM 470 (which may be an “off-the-shelf” LLM) to produce the same output given variants of a prompt. A result of fine-tuning response generating LLM 470 is that response generating LLM 470 becomes adapted to the distribution of prompt generating LLM 430. If prompt generating LLM 430 is fine-tuned using process 300, then the distribution of standardized prompts for variants of a prompt will be narrower than a prompt generating LLM that is not so fine-tuned.

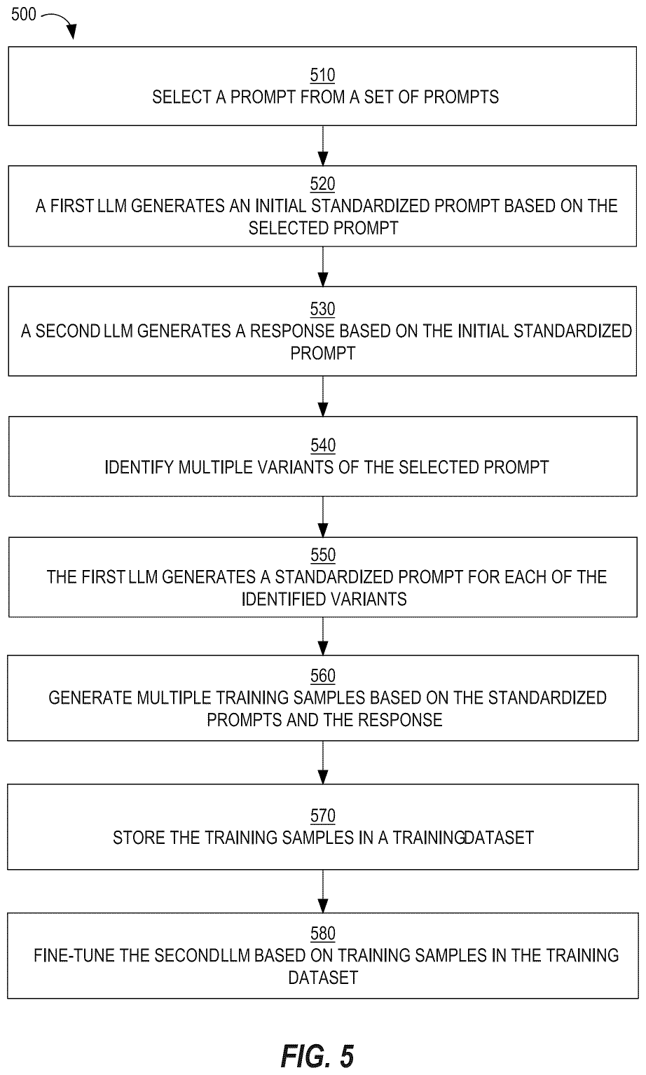

FIG. 5 is a flow diagram that depicts an example process 500 for fine-tuning a response generating LLM, in an embodiment. Process 500 may be performed by different components of system 400.

At block 510, a prompt is selected from a set of prompts. Block 510 may be performed by prompt selector 420 reading prompts from prompt storage 410.

At block 520, a first LLM generates an initial standardized prompt based on the selected prompt. Block 520 may be initiated by training sample generator 440 invoking prompt generating LLM 430.

At block 530, a second LLM generates an initial response based on the initial standardized prompt. Block 530 may be initiated by training sample generator 440 invoking response generating LLM 437.

At block 540, multiple variants of the selected prompt are identified. Block 540 may involve prompt selector 420 (or training sample generator 440) retrieving the multiple variants from prompt storage 410 or generating the variants, i.e., “on-the-fly.”

At block 550, the first LLM generates multiple standardized prompts based on the multiple variants. For example, block 550 may involve training sample generator 440 invoking the prompt generating LLM 430 multiple times, each time with a different variant of the multiple variants.

At block 560, multiple training samples are generated. Each training sample comprises (1) a different standardized prompt from the generated standardized prompts and (2) the initial response. Block 560 may be performed by training sample generator 440.

At block 570, the multiple training samples are stored in a training dataset. Block 570 may be performed by training sample generator 440 storing the training samples in training dataset storage 450.

At block 580, the second LLM is fine-tuned based on the training dataset. Block 580 may be performed by LLM fine-tuner 460 reading training samples from training dataset storage 450 and fine-tuning response generating LLM 470.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

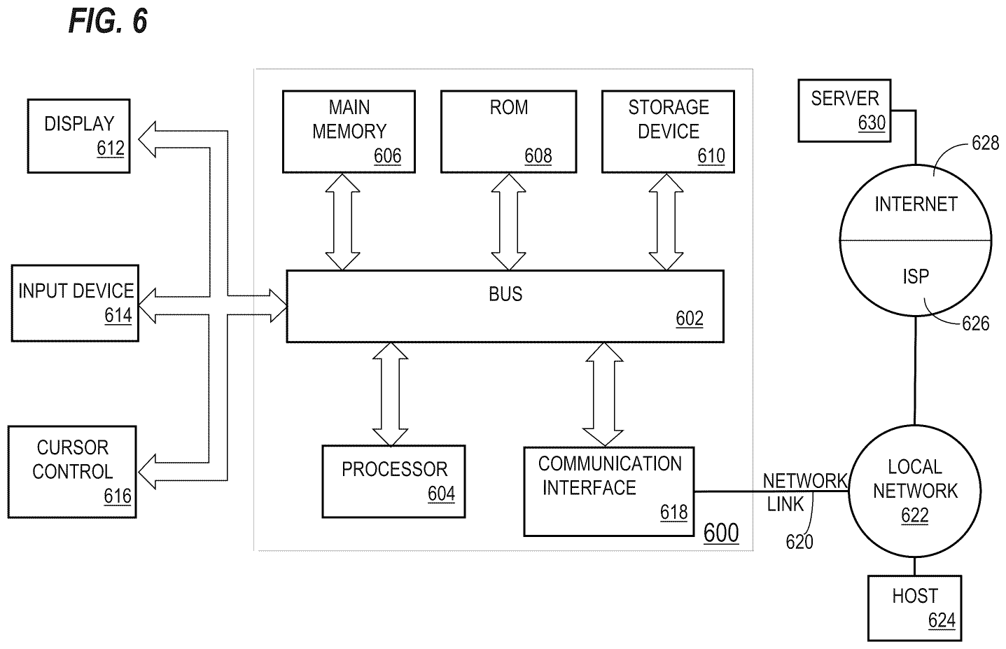

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

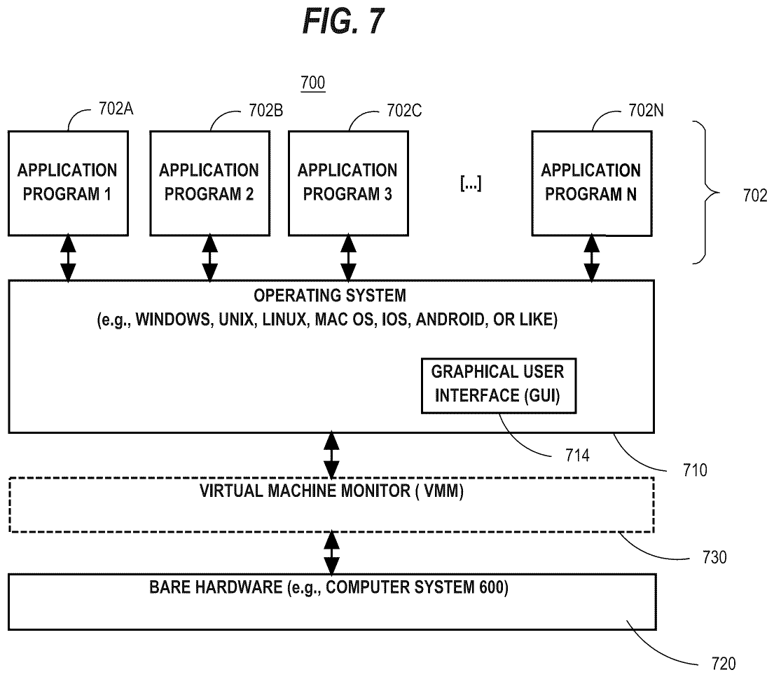

FIG. 7 is a block diagram of a basic software system 700 that may be employed for controlling the operation of computer system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computer system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
for each prompt of a plurality of prompts:
generating a plurality of variants of said each prompt;
fine-tuning a first large language model (LLM) based on said each prompt and the plurality of variants,
wherein the first LLM is trained to generate a standardized prompt based on an input prompt;
after fine-tuning the first LLM, receiving a particular prompt;
causing the first LLM to generate a particular standardized prompt based on the particular prompt;
causing a second LLM to generate a response based on the particular standardized prompt;
wherein the method is performed by one or more computing devices.

2. The method of claim 1, further comprising:
for each prompt of the plurality of prompts:
causing the first LLM to generate an output prompt;
for each variant of the plurality of variants:
generating a training sample that comprises said each variant and the output prompt;
adding the training sample to a training dataset;
wherein fine-tuning the first LLM is based on the training dataset.

3. The method of claim 1, wherein generating the plurality of variants comprises:
identifying a word within said each prompt;
identifying a plurality of synonyms of the word;
including, in the plurality of variants, a synonym of the plurality of synonyms.

4. The method of claim 1, wherein generating the plurality of variants comprises:
applying a grammar rule to said each prompt to generate a variant in the plurality of variants.

5. The method of claim 1, wherein generating the plurality of variants comprises:
identifying, in said each prompt, first text that is in the first person;
generating a variant of the plurality of variants by modifying the first text to be in the third person.

6. The method of claim 1, further comprising:
for each prompt of a second plurality of prompts:
causing the first LLM to generate a particular standardized prompt based on said prompt;
causing the second LLM to generate a response based on the particular standardized prompt;
identifying a plurality of variants of said each prompt;
causing the first LLM to generate a plurality of standardized prompts based on the plurality of variants;
generating a plurality of training samples, each comprising (1) a different standardized prompt from the plurality of standardized prompts and (2) the response;
storing the plurality of training samples in a training dataset;
fine-tuning the second LLM based on the training dataset.

7. The method of claim 6, wherein the plurality of prompts is different than the second plurality of prompts.

8. The method of claim 6, wherein causing the first LLM to generate the particular standardized prompt is performed after the first LLM is fine-tuned based on the plurality of variants of said each prompt of the plurality of prompts.

9. A method comprising:
for each prompt of a plurality of prompts:
causing a first large language model (LLM) to generate a standardized prompt based on said prompt;
causing a second LLM to generate a response based on the standardized prompt;
identifying a plurality of variants of said each prompt;
causing the first LLM to generate a plurality of standardized prompts based on the plurality of variants;
generating a plurality of training samples, each comprising (1) a different standardized prompt from the plurality of standardized prompts and (2) the response;
storing the plurality of training samples in a training dataset;
fine-tuning the second LLM based on the training dataset;
wherein the method is performed by one or more computing devices.

10. One or more non-transitory storage media storing instructions which, when executed by one or more computing devices, cause:
for each prompt of a plurality of prompts:
generating a plurality of variants of said each prompt;
fine-tuning a first large language model (LLM) based on said each prompt and the plurality of variants,
wherein the first LLM is trained to generate a standardized prompt based on an input prompt;
after fine-tuning the first LLM, receiving a particular prompt;
causing the first LLM to generate a particular standardized prompt based on the particular prompt;
causing a second LLM to generate a response based on the particular standardized prompt.

11. The one or more storage media of claim 10, wherein the instructions, when executed by the one or more computing devices, further cause:
for each prompt of the plurality of prompts:
causing the first LLM to generate an output prompt;
for each variant of the plurality of variants:
generating a training sample that comprises said each variant and the output prompt;
adding the training sample to a training dataset;
wherein fine-tuning the first LLM is based on the training dataset.

12. The one or more storage media of claim 10, wherein generating the plurality of variants comprises:
identifying a word within said each prompt;
identifying a plurality of synonyms of the word;
including, in the plurality of variants, a synonym of the plurality of synonyms.

13. The one or more storage media of claim 10, wherein generating the plurality of variants comprises:
applying a grammar rule to said each prompt to generate a variant in the plurality of variants.

14. The one or more storage media of claim 10, wherein generating the plurality of variants comprises:
identifying, in said each prompt, first text that is in the first person;
generating a variant of the plurality of variants by modifying the first text to be in the third person.

15. The one or more storage media of claim 10, wherein the instructions, when executed by the one or more computing devices, further cause:
for each prompt of a second plurality of prompts:
causing the first LLM to generate a particular standardized prompt based on said prompt;
causing the second LLM to generate a response based on the particular standardized prompt;
identifying a plurality of variants of said each prompt;
causing the first LLM to generate a plurality of standardized prompts based on the plurality of variants;
generating a plurality of training samples, each comprising (1) a different standardized prompt from the plurality of standardized prompts and (2) the response;
storing the plurality of training samples in a training dataset;
fine-tuning the second LLM based on the training dataset.

16. The one or more storage media of claim 15, wherein the plurality of prompts is different than the second plurality of prompts.

17. The one or more storage media of claim 15, wherein causing the first LLM to generate the particular standardized prompt is performed after the first LLM is fine-tuned based on the plurality of variants of said each prompt of the plurality of prompts.

18. One or more non-transitory storage media storing instructions which, when executed by one or more computing devices, cause performance of the method recited in claim 9.
